(19) United States
(12) Patent Application Publication
(10) Pub. No.: US 2026/0193473 A1
(43) Pub. Date: Jul. 9, 2026

(54) COATING COMPOSITIONS COMPRISING MAGNESIUM OXIDE AND DITHIOCARBAMATE

(71) Applicant: PRC-DeSoto International, Inc., Sylmar, CA (US)

(72) Inventors: Zhen Ye, Valencia, CA (US); Steven Michael Wand, Sylmar, CA (US); Guangliang Tang, Stevenson Ranch, CA (US); Florina Patron Herrera, Burbank, CA (US)

(73) Assignee: PRC-DeSoto International, Inc., Sylmar, CA (US)

(21) Appl. No.: 19/399,172

(22) Filed: Nov. 24, 2025

Related U.S. Application Data
(60) Provisional application No. 63/742,026, filed on Jan. 6, 2025.

(51) Int. Cl. C09D 5/08; C08K 3/22; C08K 5/00; C09D 7/61; C09D 7/63; C09D 163/00; C09D 175/04

(52) U.S. Cl. CPC C09D 5/086; C09D 7/61; C09D 7/63; C09D 163/00; C09D 175/04; C08K 2003/222; C08K 5/0091

(57) ABSTRACT

The present disclosure is directed to coating compositions comprising magnesium oxide and dithiocarbamate, wherein coating layers deposited from the compositions have corrosion resistance.

### FIELD

The present disclosure is directed to coating compositions comprising magnesium oxide and dithiocarbamate, and to substrates coated at least in part with a coating layer deposited from such compositions.

### BACKGROUND

Coating compositions comprising film-forming binders have been widely applied to, for example, appliances, automobiles, aircraft, and the like. Such coatings may also comprise corrosion inhibitors that provide corrosion resistance; certain corrosion inhibitors are potentially toxic, such as chrome. Coating compositions that provide corrosion resistance while reducing or eliminating the use of potentially toxic materials are desired.

### SUMMARY

The present disclosure is directed to coating compositions comprising (a) a film-forming component, (b) magnesium oxide, and (c) dithiocarbamate, and coating layers deposited therefrom. Methods for using the coating compositions to coat a substrate are also disclosed, as are the coated substrates themselves.

### DETAILED DESCRIPTION OF THE DISCLOSURE

The present disclosure is directed to coating compositions comprising (a) a film-forming component, (b) magnesium oxide, and (c) dithiocarbamate. Coating compositions according to the present disclosure may be deposited onto a substrate and cured as further discussed herein to form a “coating” or “coating layer”, which terms are used interchangeably herein. Accordingly, while the disclosure may be described in terms of the composition, the teachings may apply equally to a coating layer deposited therefrom.

A “film-forming” component is one that, upon hardening and/or curing, can form a continuous film on a surface. The film-forming component may comprise a film-forming resin. The film-forming component may further comprise a crosslinker reactive with the film-forming resin. Film-forming resin, film-former, resin, base and like terms may all be used interchangeably herein in reference to the film-forming resin. Crosslinker, curing agent, hardener, activator, and like terms may all be used interchangeably herein in reference to the crosslinker. The film-forming component may also be referred to herein as the “binder”. The film-forming component may comprise a film-forming resin that can react with itself, that is, undergo a “self-crosslinking” reaction, or can react with a crosslinker to form a film. Such reactions may occur at ambient or elevated temperatures.

The resin of the present disclosure is not limited and may comprise one or more organic polymers, such as acrylic polymers, polyesters, polyurethanes, polyamides, polyethers, polythioethers, polythioesters, polythiols, polyenes, polyols, polysilanes, polysiloxanes, fluoropolymers, polycarbonates, and/or epoxy resins. Generally, these compounds, which need not be polymeric, can be made by any method known to those skilled in the art. The resin may comprise functional groups, such as at least one of carboxylic acid groups, amine groups, epoxide groups, hydroxyl groups, thiol groups, carbamate groups, amide groups, urea groups, (meth)acrylate groups, styrenic groups, vinyl groups, allyl groups, aldehyde groups, acetoacetate groups, hydrazide groups, cyclic carbonate, and/or maleic acid or anhydride groups. The functional groups on the film-forming resin may be selected to be reactive with those on the curing agent, or to be self-crosslinking.

The crosslinker according to the present disclosure, when used, may be selected to have reactivity with the film-forming resin. The crosslinker may comprise a molecule or functional group that may react with the reactive groups, such as active hydrogen groups, on the resin to effectuate cure of the coating composition to form a coating layer, or coating film.

Examples of suitable crosslinkers include aminoplasts, phenoplasts, polyisocyanates, including blocked isocyanates, polyepoxides, beta-hydroxyalkylamides, polyacids, organometallic acid-functional materials, polyamines, polyamides, polysulfides, polythiols, polyenes such as polyacrylates, polyols, polysilanes and mixtures thereof. Suitable commercially available aminoplast curing agents include those from ALLNEX, such as CYMEL 303, CYMEL 1130, CYMEL 1156 and the like.

The terms “cure”, “cured”, “harden” and similar terms, which may be used interchangeably herein, refer to the ability of at least a portion of the polymerizable and/or crosslinkable components to undergo a reaction. Curing of the coating composition occurs upon subjecting said composition to curing conditions (e.g., ambient temperature, elevated temperature, actinic radiation, etc.) leading to the reaction of at least a portion of the reactive functional groups of the components of the coating composition and resulting in the crosslinking of at least a portion of the components of the composition and formation of an at least partially cured coating layer.

The coating composition may comprise a film-forming component comprising an epoxy resin and an amine crosslinker. The coating composition may comprise one or more epoxy resins comprising epoxide functional groups, such as an aromatic or aliphatic epoxy, such as an aromatic epoxy resin, such as a resin based on Bisphenol A, diglycidyl ethers of Bisphenol A, Bisphenol F, glycerol, novolacs, and the like, or epoxy modified polymers, such as epoxy modified acrylic. Suitable commercially available epoxy resins include EPON 828, EPON 862, EPON 1001, and/or EPON 8111, all available from Westlake Epoxy, and D.E.N. 431, available from Olin. Suitable amine crosslinkers include amino functional group containing curing agents including commercially available materials such as ANCAMINE 2432, ANCAMIDE 2569, ANCAMINE 2672, ANCAMINE 2686, and ANCAMINE K-54, all available from Evonik, and polyether functional amines such as those available under the trade name JEFFAMINE, such as JEFFAMINE D2000, available from Huntsman Corporation. Combinations of these materials may also be used.

The coating compositions of the present disclosure comprise magnesium oxide (MgO). The MgO may comprise particles comprising any average particle size, such as nano-sized MgO, and/or micron-sized MgO. The particle size may be reported as average particle size by the manufacturer, or optionally, the number average particle size may be determined, for example, by visually examining a micrograph of a transmission electron microscopy (“TEM”) image as described below.

For example, the MgO may be micron sized powder, or dispersions thereof, having a number average particle size of 0.5 microns or greater, such as 1 micron or greater, such as 5 microns or greater, or 50 microns or less, such as 30 microns or less, such as 20 microns or less, such as 15 microns or less, or such as 10 microns or less, or 0.5 to 50 microns, 1 to 30 microns, or 5 to 15 microns. Alternatively, or in addition, the MgO may be nano sized powder, or dispersions thereof, such as having a number average particle size of 10 nm (nanometers) or greater, such as 499 nm or less, or 100 nm or less, or 50 nm or less, or 25 nm or less, or 20 nm or less, or in the range of 10 to 499 nanometers, such as 10 to 100 nanometers, 10 to 50 nanometers, 10 to 25 nanometers, or 10 to 20 nanometers. Number average particle size reported herein was determined by visually examining a micrograph of a transmission electron microscopy (“TEM”) image, measuring the diameter of the particles in the image, and calculating the average primary particle size of the measured particles based on magnification of the TEM image.

One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

Particle size as reported herein refers to the MgO particle size at the time of incorporation into the film-forming composition. Various coating preparation methods may result in the MgO particles agglomerating, which could increase average particle size, or shearing or other action that can reduce average particle size. MgO particles are commercially available from a number of sources, such as NANO-MgO from US Research Nanomaterials, Inc. (TX, USA), such as MAGLITE Y from The Hallstar Company (IL, USA), and the like.

The shape (or morphology) of the MgO particles may vary. For example, the MgO particles may comprise particles having generally spherical morphologies and/or the MgO particles may be cubic, platy, polyhedric, or acicular (elongated or fibrous). The particles may be covered completely in a polymeric gel, not covered at all in a polymeric gel, or covered partially with a polymeric gel. Covered partially with a polymeric gel means that at least some portion of the particle has a polymeric gel deposited thereon, which, for example, may be covalently bonded to the particle or merely associated with the particle.

Any suitable amount of MgO particles may be used in the coating composition of the present disclosure. For example, the coating composition may comprise MgO in an amount of 1 wt % or greater, such as 5 wt % or greater, 10 wt % or greater, 20 wt % or greater, 30 wt % or greater, or 35 wt % or greater, such as 70 wt % or less, 50 wt % or less, or 40 wt % or less, or in an amount of 1 to 70 wt %, 20 to 50 wt %, 30 to 40 wt %, or 35 to 40 wt %, with weight percent based on the total solid weight of the composition.

The coating compositions of the present disclosure comprise dithiocarbamate. Dithiocarbamate has the general structure R₂N—C(S═)—S—R, wherein each R is the same or different and comprises hydrogen or a hydrocarbon. Particularly suitable dithiocarbamates include dialkyldithiocarbamate, examples of which include diethyldithiocarbamate and dibutyldithiocarbamate. The dithiocarbamate may be in the form of a salt or complex with, for example, zinc, sodium, ammonium, calcium, molybdenum, and/or copper. Accordingly, “dithiocarbamate” and any specific dithiocarbamate, as used herein also includes dithiocarbamate (or the specific dithiocarbamate) in its salt form and in the form of a complex.

The dithiocarbamate may comprise 1 wt % or greater, such as 2 wt % or greater, 5 wt % or greater, or 10 wt % or greater, such as 30 wt % or less, 25 wt % or less, 21 wt % or less, or 15% or less, such as 1 to 30 wt %, 5 to 25 wt %, 10 to 21 wt %, 10 to 15 wt %, or 10 wt %+/−2 wt %, with weight percent based on the total solid weight of the composition.

The MgO and dithiocarbamate function as corrosion inhibitors that may provide at least some corrosion inhibition to the underlying substrate upon which the coating composition is applied. A “corrosion inhibitor” will be understood as referring to a compound that inhibits corrosion of metals, and therefore imparts “corrosion resistance”. The effectiveness of the corrosion inhibitor in preventing corrosion of the substrate onto which the coating composition is applied and cured, that is, the corrosion resistance it provides, can be determined by salt spray corrosion testing according to ASTM B117-19. Improved corrosion resistance may be exhibited through reduced substrate pitting, scribe corrosion, scribe salting, scribe shine, scribe darkening, and/or reduction in the number and/or size of blisters present in the coating face and/or adjacent to the scribe, when compared to a composition comprising the same components except the corrosion inhibitor being tested.

The coating compositions may be thermoset or thermoplastic. Thermoset coating compositions may cure or crosslink under ambient conditions or with exposure to heat or other energy sources. Thermoplastic coating compositions may coalesce and/or dry to form a film upon evaporation of water and/or solvents.

The coating compositions of the present disclosure may be liquid coating compositions at ambient temperature, such as solvent-based coating compositions (wherein greater than 50 wt % of the total solvent is organic solvent), or water-based coating compositions (wherein 50 wt % or greater of the total solvent is water) or may be powder coating compositions.

The present compositions may be either one component (“1K”), or multi-component compositions such as two component (“2K”) or more. A 1K composition will be understood as referring to a composition wherein all the coating components are maintained in the same container after manufacture, during storage, etc. A 1K composition can be applied to a substrate and cured by any conventional means, such as by heating, forced air, and the like. Multi-component compositions will be understood as compositions in which various components are maintained separately until just prior to application. For example, the present compositions might be packaged as a 2K system, with the resin component in a first package (A) and a curing agent component in a second package (B), with all other components used in the coating composition in any combination in either package (A) or package (B) or in both, or some or all may be in one or more further packages (C).

The coating compositions of the present disclosure may additionally include other ingredients commonly used in such compositions, examples of which include additional polymers, water, solvents, such as organic solvents, colorants, fillers including clays, inorganic minerals, abrasion-resistant particles, anti-oxidants, hindered amine light stabilizers, UV light absorbers and stabilizers, surfactants, flow and surface control agents, thixotropic agents, reactive diluents, driers, catalysts, reaction inhibitors, adhesion promoting materials, such as acids and acid derivatives, phosphatized epoxy, silanes, such as epoxy silanes, and other customary additives known to those skilled in the art. As used herein, “colorants” refers to any substance that imparts color and/or other opacity and/or other visual effect to the composition.

The compositions of the present disclosure may further comprise additional corrosion inhibitors, such as metal oxides other than magnesium oxide, such as zinc oxide, and/or zinc salts, such as in a range of 1 to 20 wt %, based on total composition weight solids.

The coating compositions of the present disclosure may be substantially free, essentially free, and/or completely free of a chromium (VI)-containing material. As used herein, with respect to the chromium (VI)-containing material, the term “substantially free” means the coating composition and any resulting coating layer contains less than 0.1% by weight, the term “essentially free” means less than 0.01% by weight, and the term “completely free” means less than 0.001% by weight, based on the total solids weight of the coating composition or total weight of the coating layer.

Coating compositions of the present disclosure may be prepared using any suitable method, such as manual stirring, or air or electric mixing, such as with blade stirrers, or static mixing, magnetic stir bars, and the like. The present coating compositions may be formulated as a primer, a basecoat, a topcoat, a sealant, a gap filler, and/or an adhesive.

The present disclosure is further directed to a method for using coating compositions of the present disclosure to coat at least a portion of a substrate, comprising depositing a coating layer from the coating composition onto the substrate. The coating compositions can be deposited onto or “applied to” substrates by any suitable method known to those skilled in the art. Examples include coil coating, spraying, such as electrostatic spraying, flow coating, spin coating, curtain coating, brushing, rolling, dipping, or by the use of a fluidized bed. Liquid coating compositions may be diluted to 60 to 80% weight solids, such as 65-75% weight solids, and spray applied using HVLP, electrostatic, or other spray techniques known to those skilled in the art. Such compositions may have a viscosity of 18 to 50 seconds, such as 18 to 36 seconds, such as 23 to 50 seconds, such as 23 to 36 seconds at 25° C. as measured according to test method ISO2431 with a BYK flow cup #4.

Once the coating composition is deposited onto the substrate, it can be dried or cured by any suitable means. Examples of such suitable curing techniques include curing at ambient conditions, elevated temperature, exposure to actinic radiation, and/or combinations thereof. “Ambient” condition refers to ambient/room temperature (20° C.+/−5° C.) and humidity conditions (20% relative humidity to 80% relative humidity), while “elevated” temperatures are those at 30° C. or higher; elevated temperatures may be achieved by baking in a thermal oven, induction heating, or infrared heating. The composition may be allowed to fully cure at room temperature, and for any desired time period, such as for 2 weeks. Upon cure a coating layer is formed on the substrate.

Coating layers deposited from any of the coating compositions described herein are also within the scope of the present disclosure. Upon cure, the coating layer can have any desired dry film thickness (“DFT”). The present coating layers may impart corrosion inhibition to a metallic substrate. For example, the present coating layers, when cured to a DFT of 15 to 20 microns, impart neutral salt spray corrosion resistance greater than coating layers deposited from coating compositions comprising only MgO or only dithiocarbamate. “Neutral salt spray corrosion resistance” is determined by evaluating one or more of scribe corrosion %, scribe shine %, # of scribe blisters, largest scribe blister measurement, and # of face blisters following panel preparation and exposure according to ASTM B117-19. For example, coated panels having a coating layer deposited from the present coating compositions, after exposure to the testing conditions of ASTM B117-19, may have fewer than 10 blisters total on the face and in the scribe of the panel.

The present disclosure is further directed to substrates coated at least in part with a coating layer deposited from any of the coating compositions described herein. Suitable substrates include metal substrates, such as flexible and rigid metal substrates, metal alloy substrates, and/or substrates that have been metallized, such as nickel-plated plastic. Additionally, substrates may comprise non-metal substrates, for example, composite materials such as, for example, materials comprising carbon fibers and/or conductive carbon. The coated substrate may comprise a three-dimensional component formed by an additive manufacturing process, such as a three-dimensional formed composite.

The metal or metal alloy may comprise, for example, cold rolled steel, hot rolled steel, steel coated with zinc metal, zinc compounds, or zinc alloys, such as electrogalvanized steel, hot-dipped galvanized steel, galvannealed steel, GALVANNEAL steel, nickel-plated steel, steel plated with zinc alloy, and stainless steel, such as martensitic, duplex, ferritic, austenitic and/or precipitation hardened stainless steel. Steel substrates (such as cold rolled steel or any of the steel substrates listed above) coated with a weldable, zinc-rich or iron phosphide-rich organic coating are also suitable for use in the present disclosure. Such weldable coating compositions are disclosed in U.S. Pat. Nos. 4,157,924 and 4,186,036. The substrate may comprise aluminum, aluminum alloys, zinc-aluminum alloys such as GALFAN, GALVALUME, aluminum plated steel, and aluminum alloy plated steel substrates. Non-limiting examples of aluminum alloys include the 1000, 2000, 3000, 4000, 5000, 6000, or 7000 series, particular examples of which are 2024, 2024-T3, 7075, 7075-T6, as well as clad aluminum alloys, such as 2024-T3 clad, and cast aluminum alloys, such as, for example, the A356 series. The substrate may comprise a magnesium alloy. Magnesium alloys of the AZ31B, AZ91C, AM60B, or EV31A series also may be used as the substrate. The substrate used in the present disclosure may also comprise other suitable non-ferrous metals such as titanium or copper, as well as alloys of these materials. The substrate may also comprise more than one metal or metal alloy in that the substrate may be a combination of two or more metal substrates assembled together, such as hot-dipped galvanized steel assembled with aluminum substrates.

Substrates comprising a coating layer deposited from the coating compositions of the present disclosure may be uncoated prior to a coating layer being deposited thereon. Substrates comprising a coating layer deposited from the coating compositions of the present disclosure may comprise one or more additional layers over and/or under the layer; these multiple layers are referred to herein as a “multi-layer coating system” or “coating stack”. The coating stack may comprise a pretreatment layer, such as, for example, those described in U.S. Pat. Nos. 4,793,867 and 5,588,989, a zirconium containing pretreatment solution such as, for example, those described in U.S. Pat. Nos. 7,749,368 and 8,673,091, and/or a solgel, such as those comprising alkoxy-silanes, alkoxy-zirconates, and/or alkoxy-titanates. The coating composition of the present disclosure may be applied over at least a portion of the pretreated layer; one or more additional coating layers may be applied over at least a portion of the present coating layer. Additional coating layers may comprise primers, basecoats, color coats, monocoats, clear coats and/or topcoats. Suitable additional coating layers include any of those known in the art, and each independently may be water-based, solvent-based, in solid particulate form (i.e., a powder coating composition), or in the form of a powder slurry. The one or more additional layers may comprise a polyurethane coating. The additional coating layers may each be cured independently, or optionally applied “wet-on-wet” and cured simultaneously. As used herein, “wet-on-wet” refers to a process wherein a coating, for example a clear coat, is applied over a substantially uncured different coating, for example a color coat, and both coatings are cured simultaneously. Different layers in the coatings stack may contain components that impart a desired property, visual, and/or color effect to the coating, such as corrosion inhibitors; conductive agents such as graphene, conductive carbon black, conductive polymers, or conductive additives; pigments such as those described in U.S. Pat. No. 10,844,256 at 8/18-43, or other chromatic pigments, and the like.

The substrate may be new (i.e., newly constructed, or fabricated) or it may be refurbished, such as in the case of refinishing or repairing a component of an automobile or aircraft.

The compositions disclosed herein are not limited and may be suitable for use in various industrial or transportation applications including appliance, coil, automotive applications, commercial transport applications, rail locomotive, marine applications, and/or aerospace applications. Suitable substrates for use in the present disclosure include those that are used in the form of sheets or coils, or in the assembly of appliances or of vehicular bodies (such as door, body panel, trunk deck lid, roof panel, hood, roof and/or stringers, rivets, landing gear components, and/or skins used on an aircraft), vehicular frames, vehicular parts, motorcycles, wheels, and industrial structures and components. As used herein, “vehicle” or variations thereof includes all types of aircraft, spacecraft, watercraft, and ground vehicles. A vehicle may be an aerospace vehicle including aircraft such as airplanes including private aircraft, and small, medium, or large commercial passenger, freight, civilian and military aircraft; helicopters, including private, commercial, and military helicopters; or rockets and other spacecraft. A vehicle can include a ground vehicle such as tanks, armored cars, trailers, cars, trucks, buses, vans, construction vehicles, golf carts, motorcycles, bicycles, trains, and railroad cars. A vehicle can also include watercraft such as, for example, ships, boats, and hovercraft. The coating composition may be utilized to coat surfaces and parts thereof. A part may include multiple surfaces. A part may include a portion of a larger part, assembly, or apparatus. A portion of a part may be coated with the coating composition of the present disclosure, or the entire part may be coated. An “aircraft part” refers to any part used on any aircraft, internally or externally, and made of any substrate.

Any numerical range recited herein is intended to include all sub-ranges subsumed therein. Singular encompasses plural and vice versa. For example, although reference is made herein to “a” film-forming component, “a” film-forming resin, “a” curing agent, “a” dithiocarbamate, and the like, one or more of each of these and any other components can be used. Also, as used herein, the term “polymer” refers to prepolymers, oligomers and both homopolymers and copolymers; the prefix “poly” refers to two or more. “Amine” includes polyamine and “epoxy” includes polyepoxy. When ranges are given, any endpoints of those ranges and/or numbers within those ranges can be combined with the scope of the present disclosure. “Including”, “such as”, “for example” and like terms means “including/such as/for example but not limited to”. The term “(meth)acrylic” means methacrylic and/or acrylic, and the terms “acrylic” and “acrylate” are used interchangeably (unless to do so would alter the intended meaning) and include acrylic acids, anhydrides, and derivatives thereof, lower alkyl-substituted acrylic acids, e.g., C₁-C₂ substituted acrylic acids, such as methacrylic acid, methacrylic acid, etc., and their C₁-C₆ alkyl esters and hydroxyalkyl esters, unless clearly indicated otherwise. As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure. As used herein, the terms “on,” “onto,” “applied on,” “applied onto,” “formed on,” “deposited on,” “deposited onto,” “injected on,” “injected onto” and the like mean formed, overlaid, deposited, or provided on, but not necessarily in contact with, a substrate surface. For example, a composition “applied onto” a substrate surface does not preclude the presence of one or more other intervening coating layers or films of the same or different composition located between the composition and the substrate surface.

Aspects of the disclosure include:

Aspect 1. A coating composition comprising:
a film-forming component;
MgO; and
dithiocarbamate.

Aspect 2. The coating composition of aspect 1, wherein the film-forming component comprises a film-forming resin.

Aspect 3. The coating composition of aspect 2, wherein the film-forming component further comprises a crosslinker reactive with the film-forming resin.

Aspect 4. The coating composition of any preceding aspect, wherein the film-forming component comprises an epoxy resin and an amine crosslinker.

Aspect 5. The coating composition of any preceding aspect, wherein the MgO comprises nano-sized MgO.

Aspect 6. The coating composition of aspect 5, wherein the MgO has a number average particle size of 10 to 499 nm.

Aspect 7. The coating composition of any preceding aspect, wherein the MgO comprises micron-sized MgO.

Aspect 8. The coating composition of aspect 7, wherein the MgO has a number average particle size of 10 to 30 microns.

Aspect 9. The coating composition of any preceding aspect, wherein the dithiocarbamate comprises dialkyldithiocarbamate.

Aspect 10. The coating composition of aspect 9, wherein the dialkydithiocarbamate comprises diethyldithiocarbamate.

Aspect 11. The coating composition of aspect 9, wherein the dialkylthiocarbamate comprises dibutyldithiocarbamate.

Aspect 12. The coating composition of any preceding aspect, wherein the dithiocarbamate is in the form of a complex.

Aspect 13. The coating composition of aspect 12, wherein the complex comprises zinc.

Aspect 14. The coating composition of aspects 12-13, wherein the complex comprises sodium.

Aspect 15. The coating composition of aspects 12-14, wherein the complex comprises ammonium.

Aspect 16. The coating composition of aspects 12-15, wherein the complex comprises molybdenum.

Aspect 17. The coating composition of aspects 12-16, wherein the complex comprises calcium.

Aspect 18. The coating composition of aspects 12-17, wherein the complex comprises copper.

Aspect 19. The coating composition of any preceding aspect, wherein the coating composition comprises 1 to 70 wt % MgO, based on resin solids.

Aspect 20. The coating composition of any preceding aspect, wherein the coating composition comprises 20 to 50 wt % MgO, based on resin solids.

Aspect 21. The coating composition of any preceding aspect, wherein the coating composition comprises 30 to 40 wt % MgO, based on resin solids.

Aspect 22. The coating composition of any preceding aspect, wherein the coating composition comprises 5 to 25 wt % dithiocarbamate, based on resin solids.

Aspect 23. The coating composition of any preceding aspect, wherein the coating composition comprises 10 to 21 wt % dithiocarbamate, based on resin solids.

Aspect 24. The coating composition of any preceding aspect, wherein the coating composition comprises 10 to 15 wt % dithiocarbamate, based on resin solids.

Aspect 25. The coating composition of any preceding aspect, wherein the coating composition comprises 10 wt %, +/−2 wt %, dithiocarbamate, based on resin solids.

Aspect 26. A coating layer deposited from a coating composition of any preceding aspect.

Aspect 27. The coating layer of aspect 26, wherein the coating layer, when cured to a dry film thickness of 15 to 20 microns, imparts neutral salt spray corrosion resistance, when tested according to ASTM B117-19, greater than that imparted by a coating layer deposited from the same coating composition comprising only MgO or only dithiocarbamate.

Aspect 28. The coating layer of aspects 26-27, wherein the coating layer has fewer than 10 face and/or scribe blisters.

Aspect 29. The coating layer of aspects 26-28, wherein the coating layer has SKYDROL resistance as determined according to the SKYDROL Resistance Test.

Aspect 30. A method for using the coating composition of aspects 1-26 to coat at least a portion of a substrate, comprising depositing a coating layer from the coating composition onto the substrate.

Aspect 31. A substrate prepared according to the method of aspect 30.

Aspect 32. The substrate of aspect 31, wherein the substrate comprises metal.

Aspect 33. The substrate of aspect 32, wherein the metal comprises aluminum and/or an aluminum alloy.

Aspect 34. The substrate of aspect 33, wherein the aluminum alloy comprises a 2000, 3000, 4000, 5000, 6000, or 7000, series aluminum alloy.

Aspect 35. The substrate of aspect 34, wherein the aluminum alloy comprises a 2024 aluminum alloy, 2024-T3 grade aluminum alloy, a 7075 aluminum alloy, and/or a 6061 aluminum alloy.

Aspect 36. The substrate of aspect 31, wherein the substrate comprises a composite material.

Aspect 37. The substrate of any of aspects 31-36, wherein the substrate is a three-dimensional vehicle part.

Aspect 38. The substrate of any of aspects 31-37, wherein the coating layer comprises part of a coating stack.

Aspect 39. The substrate of any of aspects 31-38, wherein the substrate is uncoated prior to a coating layer of aspects 1-25 being deposited thereon.

Aspect 40. The substrate of any of aspects 31-39, wherein the substrate further comprises one or more additional coating layers.

Aspect 41. The substrate of aspect 40, wherein the one or more additional layers comprises a polyurethane coating.

Aspect 42. The substrate of any of aspects 32-41, wherein the substrate is an aircraft or aircraft part.

### EXAMPLES

The following examples are intended to illustrate the disclosure and should not be construed as limiting the disclosure in any way.

### Coating Preparations: CONTROLS 1-3 and EXAMPLES 1-2

Two component (2K), epoxy-amine coating compositions, CONTROLS 1-3, and EXAMPLES 1 and 2, were prepared using the materials and weights as shown in Table 1.

For each PART A and PART B, the raw materials were combined and mixed for 360 min using an LAU Disperser DAS 200 (LAU GmbH) to a Hegman grid of 5.5. For each PART A and PART B, the LAU Disperser was charged with 2 millimeter grinding media available from Fox Industries.

Before application of the coating compositions, PART A and PART B of each composition were combined under mild agitation by hand. The coating compositions all had a viscosity of 20-36 seconds(s) as measured according to ISO2431 (2019) with a BYK flow cup #4. The compositions were stirred until each was homogenous and applied as indicated below.

TABLE 1
Coating Compositions

| | CONTROL | CONTROL | CONTROL | EXAMPLE | EXAMPLE |
|---|---|---|---|---|---|
| | 1 | 2 | 3 | 1 | 2 |
| Raw Materials | Wt. (g) | Wt. (g) | Wt. (g) | Wt. (g) | Wt. (g) |
| Part A | | | | | |
| Amine Resin | 18.16 | 18.16 | 18.16 | 18.16 | 18.16 |
| Dispersant | 1.60 | 1.60 | 1.60 | 1.66 | 1.66 |
| Pigments | 11.60 | 11.60 | 11.60 | 11.60 | 11.60 |
| Nano MgO¹ | 15.18 | 0.00 | 0.00 | 15.18 | 15.18 |
| Solvents | 32.89 | 31.10 | 31.10 | 32.89 | 32.89 |
| Barium Sulfate² | 22.98 | 37.54 | 37.54 | 22.98 | 22.98 |
| Subtotal Part A | 102.47 | 100.00 | 100.00 | 102.47 | 102.47 |
| Part B | | | | | |
| Epoxy Resin | 25.35 | 25.39 | 25.39 | 25.46 | 25.39 |
| Solvents | 18.26 | 17.10 | 16.06 | 17.23 | 16.06 |
| ZDTC | 0.00 | 4.02 | 8.04 | 4.02 | 8.04 |
| Subtotal Part B | 43.62 | 46.59 | 49.49 | 46.71 | 49.49 |
| Total Weight of | 146.10 | 146.59 | 149.49 | 149.18 | 151.96 |
| Admix (Part A and | | | | | |
| B | | | | | |
| Nonvolatile Material | 61.52 | 63.65 | 65.10 | 63.02 | 64.47 |
| in Admix (%) | | | | | |
| Resin Solids in | 26.90 | 26.84 | 26.32 | 26.42 | 25.89 |
| Admix (Wt. %) | | | | | |
| MgO/Resin(Wt. %) | 38.6% | 0.00 | 0.00 | 38.5% | 38.6% |
| ZDTC/resin³(Wt. %) | 0.0 | 10.2% | 20.4% | 10.2% | 20.4% |

¹Nano particle size MgO, with 20 nm average particle size, commercially available from US Research Nanomaterials, Inc., TX.
²Barium sulfate, Sachtleben Blanc Fixe N, commercially available from Solvay.
³ZDTC, Zinc(II) diethyldithiocarbamate, commercially available from Sigma Aldrich.

### Substrates and Coating Applications:

Coating compositions were spray applied on 3-inch×6-inch×0.032 inch bare 2024-T3 grade aluminum panels, from Priority Metals, Inc.

Panels were machine-scrubbed with an abrasive pad, SCOTCHBRITE 7447 PRO, wiped with methyl ethyl ketone (MEK) solvent, and dried under ambient conditions prior to coating application.

CONTROL 1-3 and EXAMPLE 1-2 coating compositions were applied using HVLP spray equipment (Vendor: Anest Iwata, Model: LPH300LV) with a tip size of 1.2 mm and a pressure setting of 30 psi, within 60 minutes of combining PART A and PART B. The coatings were applied to a dry film build of 0.6-1.0 mils (15-20 μm) measured using an Eddy Current Dry Film Thickness Guage Model Positector 6000 from DeFelsko.

The applied coatings were cured at ambient conditions for 7 days prior to testing coated substrates.

### Coating Test Methods:

Coated substrates were evaluated using the following test methods:

Neutral salt spray corrosion (NSS) resistance: Corrosion resistance was determined by exposing coated cured panels according to ASTM B117-19. Three test panels were prepared as described above for each coating composition. Two diagonal marks (scribe lines) were machine scribed extending from corner to corner on each panel. The width of scribe lines was between 0.031 and 0.064 inch and penetrated through the coating and into the base metal. Test panels were exposed to 5 percent salt spray fog for 4000 hours, with painted side up.

The panels were examined for corrosion and blisters after salt spray exposure according to the following scale:

Scribe Corrosion (%): Rating was 0-100 and number represents percent of scribe which has visible corrosion. A lower rating number is better.

Shiny/Nature of Scribe (%): Rating was 0-100 and number represents percent of scribe which is shiny, maintaining bright appearance. A higher rating number is better.

Blisters: Total number of blisters were counted adjacent to scribe (Scribe Blister #) or away from scribe (Face Blister #, that is, on the face of the panel). Blisters are counted up to 30. A lower rating number is better.

Largest Scribe Blister: The size of the largest blister adjacent to the scribe is measured in inches (in). A smaller size is better.

Crosshatch Adhesion Testing: Crosshatch adhesion was determined according to ASTM D3359-23 (Standard Test Methods for Measuring Adhesion by Tape Test), method B with the following scale: 5B: the edges of the cuts are smooth, none of the squares are detached, 4B: small flakes are detached, less than 5% of the crosshatch area is affected, 3B: small flakes are detached, 5% to less than 15% of the crosshatch area is affected, 2B: the coating has flaked, 15% to less than 35% of the crosshatch area is affected, 1B: whole squares have detached, 35% to less than 65% of the crosshatch area is affected, 0B: flaking and detachment is worse than 1B, 65% or more of the area is affected. Dry crosshatch adhesion was tested after the panels were cured. A rating scale of greater than 3B is acceptable.

Pencil Hardness: Pencil hardness was determined in accordance with ASTM D3363-22 (Standard Test Method for Film Hardness by Pencil Test) after the panels were cured. The following pencil hardness scale was used as listed in order of softer to harder: 6B, 5B, 4B, 3B, 2B, B, HB, F, H, 2H, 3H 4H, 5H, 6H. Dry pencil hardness was tested after the panels were cured. Acceptable dry pencil hardness is 4H or harder.

SKYDROL Resistance: SKYDROL Resistance was tested by immersing fully cured coated panels in the test fluid, hydraulic fluid SKYDROL LD4, for 30 days at ambient temperature. Fluid resistance was then tested after the panels were pulled out from the test fluid. Excess fluid was removed by gauze and the panels were rinsed with water and dried at ambient conditions for an hour before Pencil hardness testing was performed using ASTM D3363-22. This test is referred to herein as the “SKYDROL Resistance Test”. A pencil hardness of greater than 2B has “SKYDROL resistance”.

### Coating Test Performance:

Coating testing results are shown in Tables 2 to 3.

TABLE 2
4000 Hours NSS Corrosion Resistance for Coating Layers on Aluminum Panels

| | CONTROL 1 | CONTROL 2 | CONTROL 3 | EXAMPLE 1 | EXAMPLE 2 |
|---|---|---|---|---|---|
| Scribe | 63 | 83 | 100 | 15 | 12 |
| Corrosion % | | | | | |
| Scribe Shine % | 37 | 0 | 0 | 85 | 10 |
| Scribe Blisters | 12 | 12 | >30 | 1 | 1 |
| (#) | | | | | |
| Face blister (#) | >30 | 0 | 0 | 0 | 0 |
| Largest Scribe | 0.256 | 0.1605 | 0.125 | 0.042 | 0.109 |
| Blister (inch) | | | | | |

As shown in Table 2, the coating compositions according to the present disclosure (Examples 1 and 2), showed improved overall corrosion resistance as compared to coating compositions having only one of MgO and dithiocarbamate (CONTROLS 1-3).

TABLE 3
Physical Properties for CONTROLS 1-3
and EXAMPLES 1-2 on Aluminum Panels.

| | CONTROL | CONTROL | CONTROL | EXAMPLE | EXAMPLE |
|---|---|---|---|---|---|
| | 1 | 2 | 3 | 1 | 2 |
| Crosshatch | 5B | 4B | 3B | 4B | 4B |
| Adhesion | | | | | |
| (Dry) | | | | | |
| Pencil | 5H | 5H | 5H | 5H | 4H |
| hardness | | | | | |
| (Dry) | | | | | |
| SKYROL | 4H | 4H | 4H | 4H | F |
| RESISTANCE | | | | | |
| (Pencil | | | | | |
| hardness) | | | | | |

As shown in Table 3, coating layers formed from compositions according to the present disclosure, Examples 1 and 2, provided corrosion resistance while maintaining acceptable dry crosshatch adhesion and dry pencil hardness. EXAMPLES 1 and 2 also had acceptable film integrity after SKYDROL immersion testing, retaining pencil hardness greater than 2B.

Whereas particular features of the present disclosure have been described above for purposes of illustration, it will be evident to those skilled in the art that numerous variations of the details of the coating composition, coating, and methods disclosed herein may be made without departing from the scope in the appended claims.

We claim:

1. A coating composition comprising:
a. a film-forming component;
b. MgO; and
c. dithiocarbamate.

2. The coating composition of claim 1, wherein the film-forming component comprises a film-forming resin and crosslinker therefore.

3. The coating composition of claim 2, wherein the film-forming resin comprises an epoxy resin and the crosslinker comprises amine.

4. The coating composition of claim 1, wherein the MgO comprises nano-sized MgO, micron-sized MgO, or both.

5. The coating composition of claim 1, wherein the dithiocarbamate comprises dialkyldithiocarbamate.

6. The coating composition of claim 5, wherein the dialkyldithiocarbamate comprises diethyldithiocarbamate and/or dibutyldithiocarbamate.

7. The coating composition of claim 1, wherein the dithiocarbamate comprises a complex with zinc, sodium ammonium, molybdenum, calcium, and/or copper.

8. The coating composition of claim 1, wherein the composition comprises 20 to 50 wt % MgO, based on total resin solids.

9. The coating composition of claim 1, wherein the composition comprises 5 to 25 wt % dithiocarbamate, based on total resin solids.

10. The coating composition of claim 9, wherein the composition comprises 10 wt %+/−2 wt % dithiocarbamate, based on total resin solids.

11. A coating layer deposited from the coating composition of claim 1.

12. The coating layer of claim 11, wherein the layer, when cured to a dry film thickness of 15 to 20 microns, has fewer than 10 face and/or scribe blisters when tested according to ASTM B117-19.

13. The coating layer of claim 11, wherein the layer, when cured to a dry film thickness of 15 to 20 microns, has SKYDROL resistance as determined according to the SKYDROL Resistance Test.

14. A method for using the coating composition of claim 1 to coat at least a portion of a substrate, comprising depositing a coating layer from the coating composition onto the substrate.

15. A substrate prepared according to the method of claim 14, wherein the substrate comprises metal and/or a composite material.

16. The substrate of claim 15, wherein the substrate is an aircraft or aircraft part.

17. The substrate of claim 16, wherein the coating layer comprises part of a coating stack.

18. The substrate of claim 17, wherein the coating stack further comprises a polyurethane layer on top of at least a portion of the coating layer.

19. The substrate of claim 15, wherein the metal comprises aluminum and/or an aluminum alloy.

20. The substrate of claim 19, wherein the aluminum alloy comprises a 2024 aluminum alloy, 2024-T3 grade aluminum alloy, a 7075 aluminum alloy and/or a 6061 aluminum alloy.
